(19) United States
(12) Patent Application Publication
(10) Pub. No.: US 2023/0057281 A1
(43) Pub. Date: Feb. 23, 2023

(54) Self leveling one gallon paint can holder-extension ladder attachment

(71) Applicant: Johnnie Sterling, JR., Licking, MO (US)

(72) Inventor: Johnnie Sterling, JR., Licking, MO (US)

(21) Appl. No.: 17/300,568

(22) Filed: Aug. 23, 2021

(51) Int. Cl. E06C 7/14

(52) U.S. Cl. CPC E06C 7/14

(57) ABSTRACT

This invention is specifically, useful in the field of home improvement necessities, serving a painters need without frustrations when the use of an extension ladder is necessary.

This invention is made to be attached to a extension ladder.

The inventions circular grooved cylinder is fashioned to hold a one gallon paint can within the cylinder and the grooves. The cylinder is mounted specifically for the can to swivel backwards and forwards when attached to the ladder, keeping the paint can level.

### BACKGROUND OF THE INVENTION

¶L field of endeavor to which this invention pertains is defined under the United States Patent Office classification definition as a “machine.” This invention makes it easy to secure the gallon paint can while high upon an extension ladder. In the past unlike the small unfolding step ladder, the extension ladder do not have a stable platform for holding a gallon paint can. In fact the norm for keeping a gallon paint can up on the extension ladder up until now was with a S shaped fashioned wire. This S shaped wire or hanger formed into a S had to be durable in strength to hold on to the stair and gallon can handle. This gallon paint can handle made it difficult to easily dip a paint brush for more paint to be put onto the brush.

### BRIEF SUMMARY OF THE INVENTION

The self leveling one gallon paint can holder—extension ladder attachment is conveniently USEFUL, safe and A NEW simple way of painting from the one gallon paint can while up high an extension ladder. The one gallon paint can and it's contents self levels because of the circular fashioned aluminum cylinder that swivels and is made on this extension ladder attachment. This attachment resolves the problem of the gallon paint can handle obscuring the dipping of the paint brush for more paint. This is a NOVEL invention and contributes to the field of home improvement necessities, making it NON-OBVIOUS.

### BRIEF DESCRIPTION OF THE SEVERAL VIEWS OF THE DRAWINGS

FIG. 1A, “FIG.” 1 shows a top surface view without the fashioned front curl, side and end folds complete, but shows the oval shape circumference hole cut out.

FIG. 1A, “FIG.” 2 shows a top surface view with fashioned curl, sides and end folds complete facing left.

FIG. 1A “FIG.” 3 shows a bottom view with fashioned curl, sides and end folds complete facing right.

FIG. 2A, “FIG.” 1 shows a view of the fashioned aluminum cylinder with side mount assembly's not welded.

FIG. 2A, “FIG.” 2 shows a view of the fashioned aluminum cylinder with side mount assembly's welded, with a view of binding post and binding screws needed for assembling FIG. 1A “FIG.” 3 and FIG. 2A, “FIG.” 2 together.

FIG. 2A, “FIG.” 3 shows a view of FIG. 2A, fashioned aluminum cylinder assembled to the bottom of FIG. 1A, “FIG.” 3 secured with binding post and binding screws.

FIG. 2A, “FIG.” 4 shows a side view of assembled FIG. 2A “FIG.”2 and FIG. 1A, “FIG.” 3 showing swivel of the fashioned aluminum cylinder in a slanted position were it completed and attached to an extension ladder in any up right ladder angle.

FIG. 3A, “FIG.” 1 shows a view of the fashioned 5/16 inch HIGH-STRENGTH-STEEL rod, with view of a support rod needed for assembly to complete FIG. 3A, “FIG.” 1.

FIG. 3A shows a view of the support rod assembled to FIG. 3A, “FIG.” 1. FIG. 3A, “FIG.” 3 shows a view of the assembled 5/16 inch fashioned HIGH STRENGTH-STEEL, or CAST STEEL rod attached under the end fold and welded to FIG. 1A, “FIG.” 3.

“FIG.” 4 shows an over all view of the invention completed, attached and ready for use on an extension ladder.

### DETAILED DESCRIPTION OF THE INVENTION

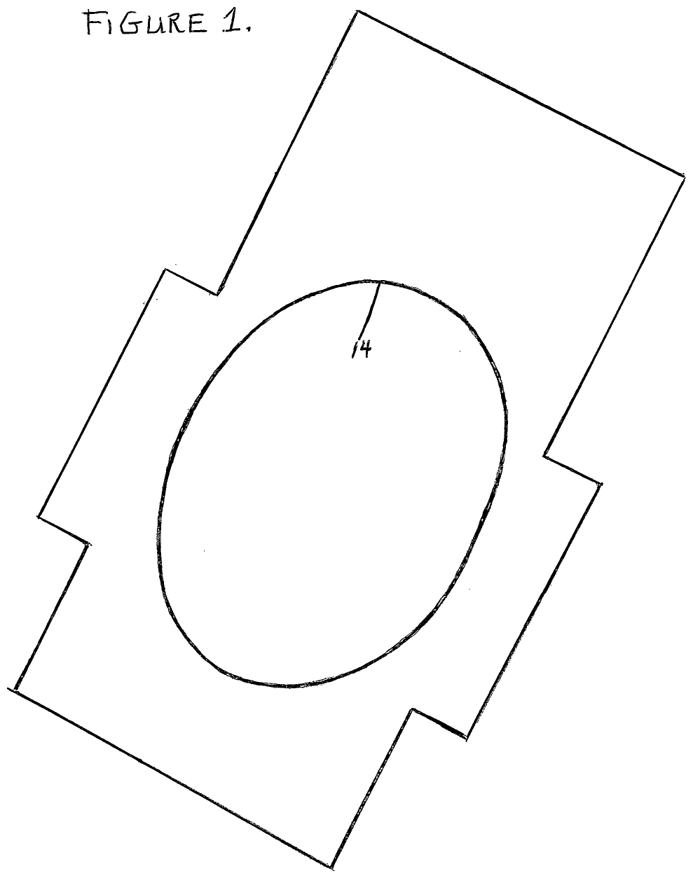

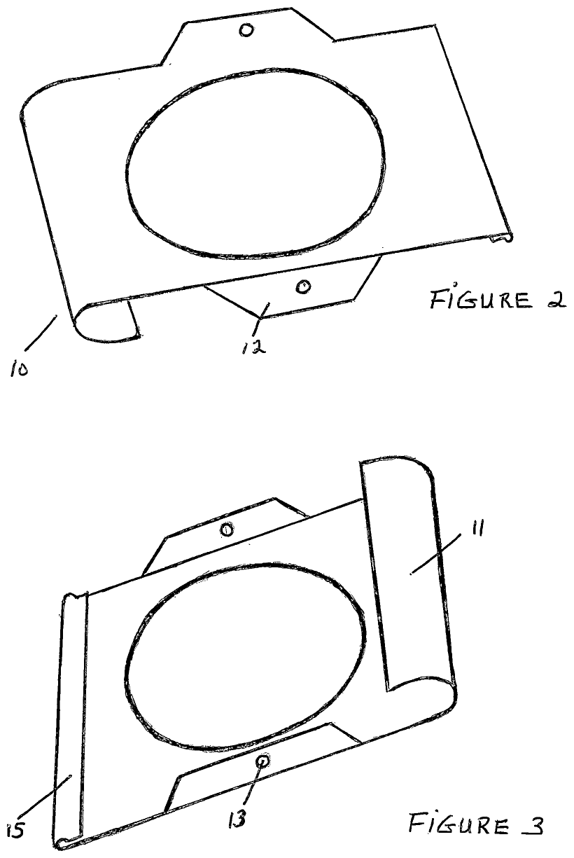

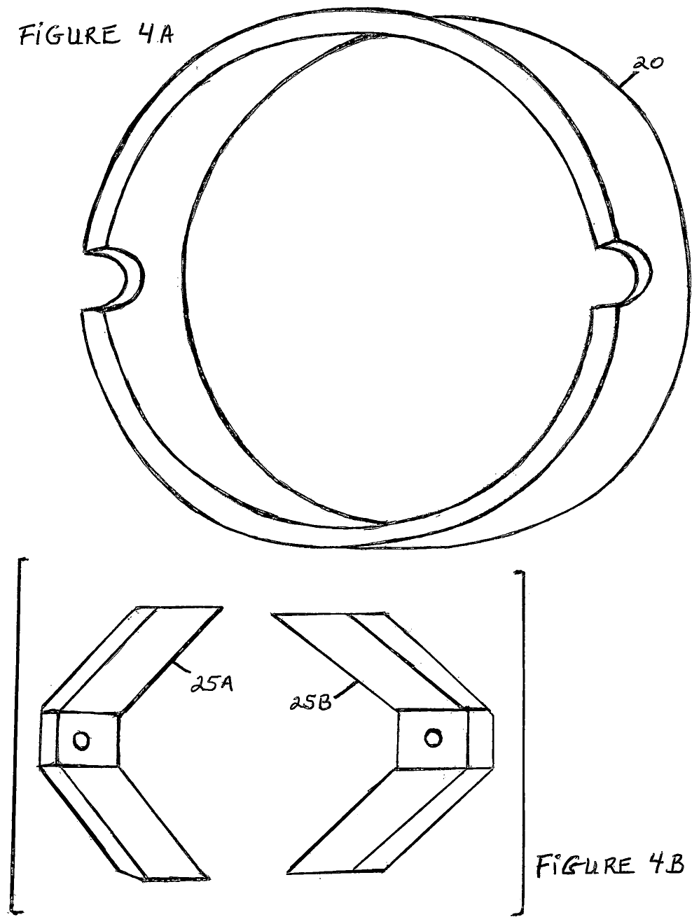

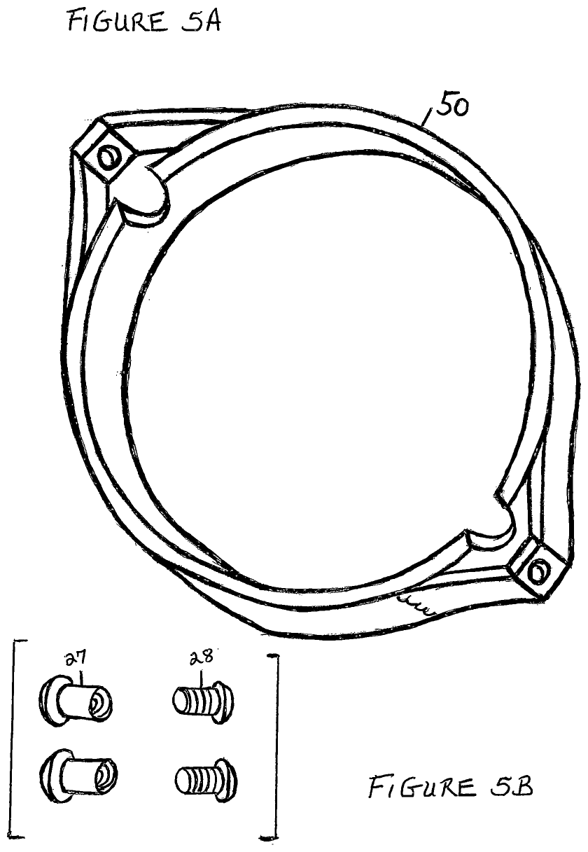

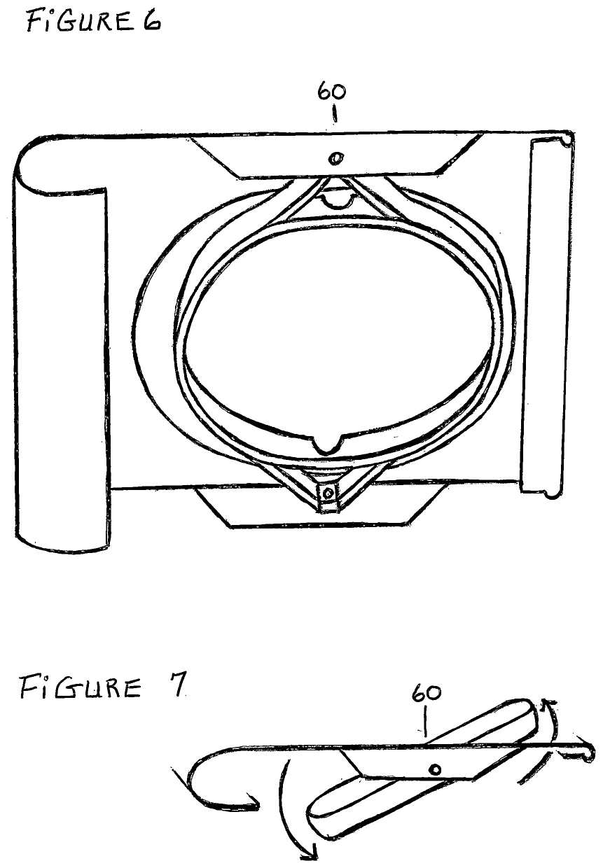

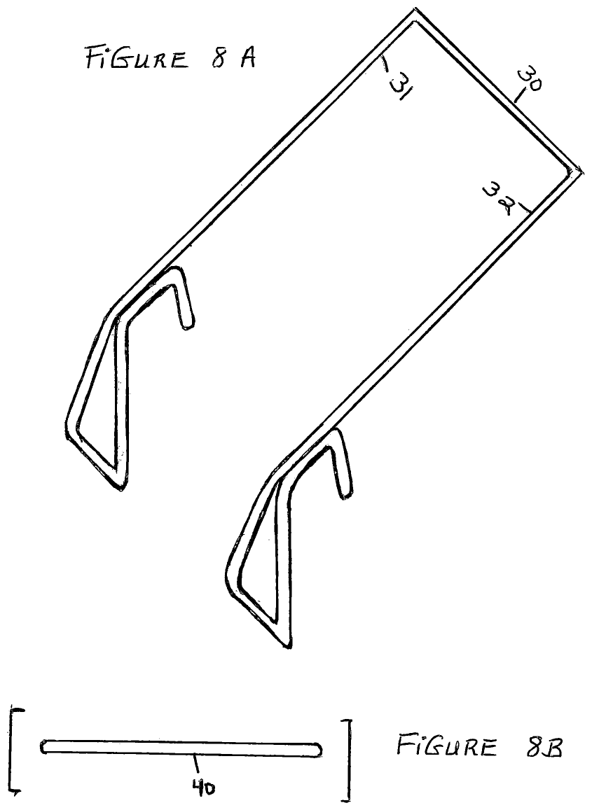

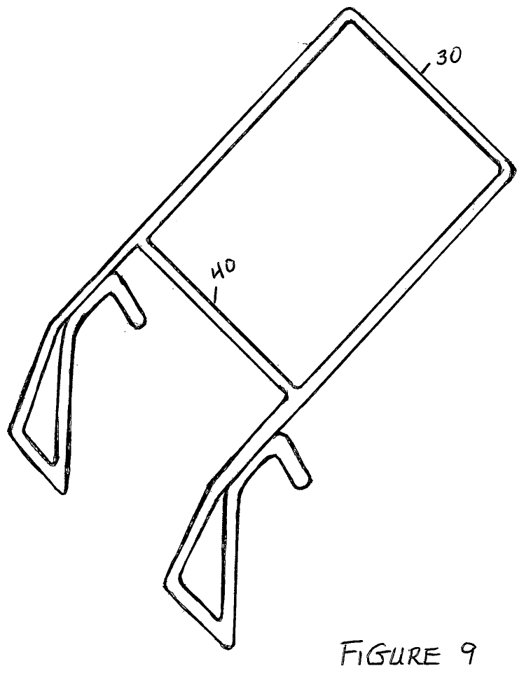

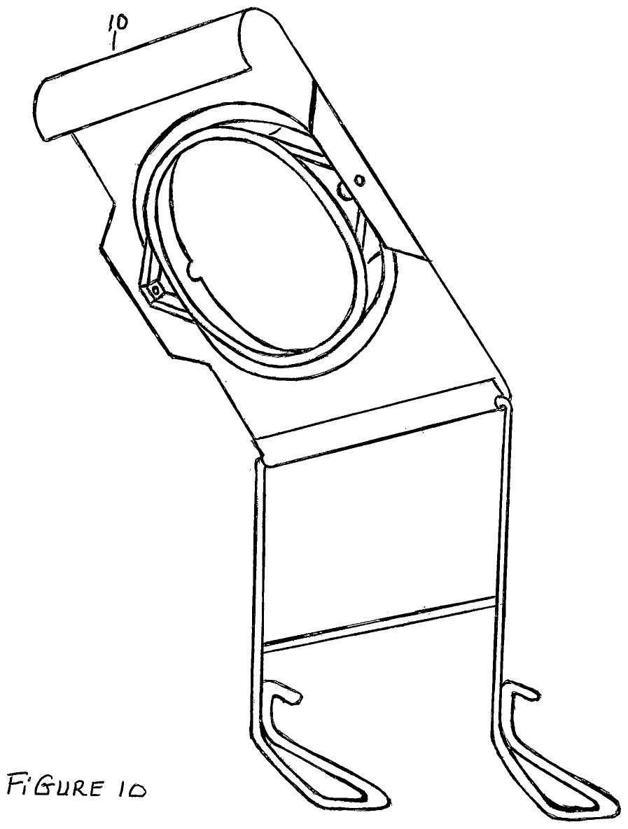

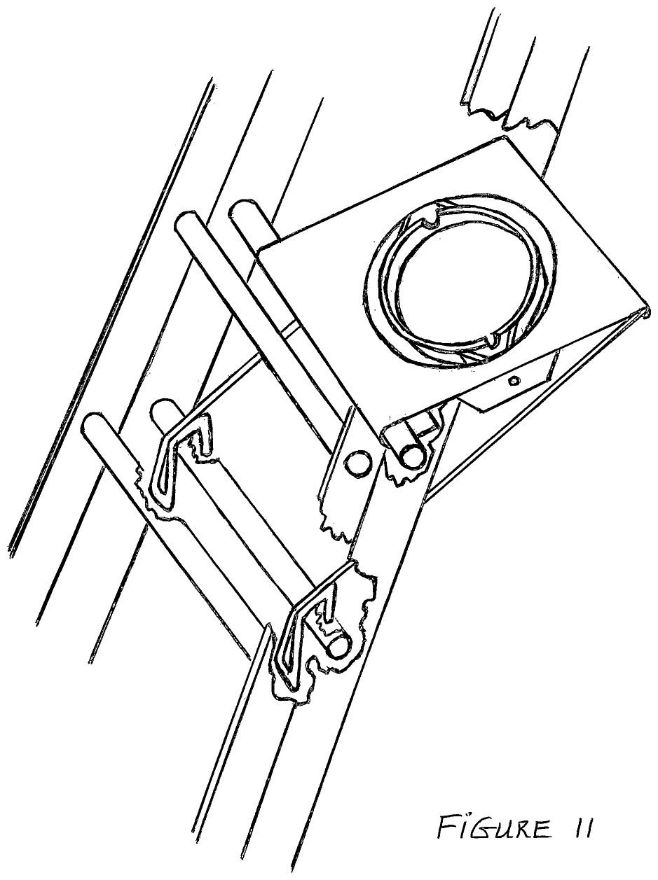

This invention is made in three (3) reference characters, FIG. 1A, FIG. 2A and FIG. 3A. FIG. 2A requires adding two (2) welded side mounts to complete FIG. 2A, the fashioned circular shaped cylinder, which is then attached securely to FIG. 1A, by binding post and binding screws. Both FIG. 1A, the invention foundation and FIG. 2A and the (2) two side mounts to complete FIG. 2A are all made of aluminum.

FIG. 3A and its support rod are made of 5/16 inch HIGH-STRENGTH-STEEL or CAST SAIL, not cold rolled. This reference character FIG. 1A “FIG.” 1 shows a top view that shows a circular hole cut out, which is a 26 inch (oval shaped) circumference cut out.

TO begin making and assembling this invention you will need a sheet of aluminum 16 inches long by 12½ inches in width and 3/16 inch thick. Steps to cut out the 26 inch oval shaped circumference is to first draw a oval shaped circumference. Make it exactly 8¾ inches top to bottom to get a fair idea while shaping it from the bottom.

Make a measurement of 6 ¼ inches from the 12½ inch width of this aluminum material and make it you center mark to begin your cut. This 6¼ inch center marked point should begin center with including a measurement of 2½ inches from the length of the material at the end of the 16 inch length.
If need place this drawing on the sheet of aluminum before beginning to cut to give you same idea.

The oval circumference you may have drawn out, lay on the material before actually cutting. Now begin at the 6¼ inch center mark made center of the width and the 2½ inch center mark made from the end of the length. This should leave 3 inches on each side of the materials width. These 3 inches that remain on each side of the aluminum will allow roan to make the folds for each side making the invention folds complete.

See; drawing in FIG. 1A “FIG.” 1., “FIG.” 2 and “FIG.” 3. Steps to cut out the folds start from the back end where the oval circumference cut began its 2½ inch center marking point.

From this back end measure up towards the front opposite end 2¾ inches in length, then 1¾ inches from the width at the corner and cut off the material. Repeat this 2¾ by 1¾ inch square cut on the opposite back end corner. TO cut the front end of the folds on each side, measure 8 inches from the length towards the back end and 1¾/inches from the width at the front end of the aluminum material and cut this measurement off. Repeat this same 8 inch by 1¾ inch removal of the material on the opposite front side of the front end of this aluminum material. See; drawing in FIG. 1A, “FIG.” 1.

Before bending the fold in the down position the measurements of the folds on each side should be 7¼ inches. Once each side fold is precisely cut to measurement further cuts on the folds can be made. Now cut ½ inch off on each end of the fold in an upward oblique angled position. This will leave the top of the fold that will bend down 7¼ inches in length and the bottom 6¼ inches in length from the ½ inch oblique angled cut. Repeat these measured angled cuts of a ½ inch on the opposite side fold. About 3 ⅝ inches center of the 7 ¼ length fold and 1 inch down from the top of each side fold, drill a 4/8 inch hole through each side fold.

Steps to make the front fashioned curl is, to measure a 4 1/16 inches from the 16 inch length front end. Make the first curl, fold the aluminum material 1½ inch vertically down. Next for the completion curl, fold the aluminum horizontally backwards 2½ inches towards the opposite back end length of the material. Once the front fashioned curl is complete, the top oval circumference opening cut should be a distance of 2¾ inches from the first downward front end fold or curl.

FIG. 2A is made of a 1 inch wide, 20 inch long and 3/16 inch thick aluminum strip, that is to be fashioned into a circular shaped cylinder. When this 20 inch circumference is finished it should be welded together to make the circled cylinder. Then smooth out the rough welded area. Next a 6/8 inch half circular grooves should be cut out directly across one side from the other on this circular cylinders top edge. These 6/8 inch grooves are fashioned so the one gallon paint can handle attachment will rest in these grooves.

This FIG. 2A, has (2) two separate slightly angled fashioned aluminum mounts made with the same 3/16 inch thickness and same 1″ inch width as the fashioned circular aluminum cylinder.

See; FIG. 2A, “FIG.” 1 for view of these two (2) side mount attachment. Once these two side mounts are fashioned, they too must have a 4/8′ inch hole drilled in the center of each mount. Each mount is then welded to the side of the cylinder, where the 6/8″ inch half circular cut out grooves are, as shown in FIG. 2A, “FIG.” 1 and FIG. 2A, “FIG.” 2 drawings.

These two separate side mounts should be made or fashioned to weld to the circular aluminum cylinder exactly with a 1″ inch separation distance. Once these (2) two mounts are welded with the 1″ inch separation of the mounts from the cylinder, this will allow the section of the mounts with the 4/8″ inch hole to align flush with the side fold holes of FIG. 1A. Smooth out the rough welded area. Once these mounts are welded correctly and with necessary separation, FIG. 2A will be complete. Then this cylinder will be attached to the bottom view of FIG. 1A “FIG.” 3, with two stainless steel binding post measuring ½″ inch barrel diameter, 7/16″ inch barrel length, with a ⅜″ inch barrel depth and binding screws, thread length ⅜″ inches as shown in the FIG. 2A “FIG.” 3., drawing.

FIG. 3A, is made of 5/16 inch thick HIGH-STRENGTH-STEEL or CAST STEEL rod, not cold rolled. This steel rod is to be fashioned, folded and bent as shown in FIG. 3A, “FIG.” 2 drawing. The total length of this rod should be 57 inches, to complete all the folds and bends for this invention. The first bend should begin at 23⅝ inches, by making a 45 degree bend. For the next bend measure over 9¾ inches and make the same 45 degree bend. This will create the 9¾ inch horizontal back and about 23⅝ inches on each opposite side of this 9¾ inch horizontal back to finish the additional bends for FIG. 3A.

On each remaining side with the horizontal 9¾ inch back pushed away from you and both extending rods extended towards you begin to make your bends. Measure 14½ inches from the horizontal 9¾ inch back, then make an Oblique bend downward. Do this Oblique bend to both extended rods. Once both (sides) rods are bent downward 2½ inches, make a 1″ inch bend to the right on each extended rod. From the 1 inch right bend, make an upward bend of 2½ inches. Make this bend also on the opposite extended steel rod, with the extended steel rods still extended towards you make a backwards bend on each rod about 1 ¼ inches. When these 1¼ inch backwards bends are complete, on each extended steel rod make the final downward bend, and squeeze the folds close together. All these bends are illustrated in the drawings of FIG. 3A, “FIG.” 1.

Finally with all the tends made in FIG. 3A, the steel support rod should be welded about 12 inches from the horizontal 9¾ inch tack of the steel rod. This steel support rod should be a measurement of about 9 ⅛ inches before being welded to FIG. 3A, as shown in FIG. 3A, “FIG.” 2., drawing of the invention. With the steel rod complete with the support rod, this 9 ¾ inch horizontal back should be secured within the allowable 1½ inch end fold of FIG. 1A, as shown in FIG. 3A “FIG.” 3., drawing of this invention. Allowing for movement of FIG. 3A, steel rod before permanent welding of the 1½ inch end fold of FIG. 1A.

I claim:

1. (canceled)

2. (canceled)

3. (canceled)

4. A self-leveling paint can holder comprising:
a sheet having an upper planar surface, a lower planar surface, first and second ends opposite to one another, first and second side edges, a first side fold tab extending from the first side edge and a second side fold tab extending from the second edge, a cutout is contained within a central portion of the sheet, wherein the first end is bent downwardly with respect to the upper planar surface to form a first hooked end, the second end is bent downwardly with respect to the upper planar surface to form a second hooked end, and the first and second side fold tabs are each bent downwardly with respect to the upper planar surface to form mounting flanges;
a cylindrical portion defined by a first circumferential edge, a second circumferential edge and an annular sidewall, the first circumferential edge comprising a first groove and an opposing second groove, first and second side mounts mounted on opposite sides of the annular sidewall, each side mount having a respective mount hole;
a rod bent into a substantially U-shaped frame comprising two substantially parallel segments connected together by a third linear segment, and first and second ends of the rod being bent to form respective hooked ends;
wherein the side mounts of the cylindrical portion are respectively pivotably mounted to the first and second side fold tabs so the cylindrical portion can rotate within the cutout of the sheet;
wherein the second hooked end of the sheet receives and pivotably retains the third linear segment of the rod;
wherein the first hooked end of the sheet is configured to mount to a step of a ladder, and the hooked ends of the rods are configured to mount to a second step of the ladder;
wherein the cylindrical portion is configured to receive a gallon paint can and the first and second grooves of the cylindrical portion are configured to support handle lugs of the paint can, such that if the ladder is angled the paint can will be retained in a level orientation by the paint can holder.

5. The self-leveling paint can holder as set forth in claim 4, wherein the cutout is oval-shaped.

6. The self-leveling paint can holder as set forth in claim 4, wherein the sheet, and the cylindrical portion are made from aluminum.

7. The self-leveling paint can holder as set forth in claim 4, wherein the first and second mounts are welded to the annular sidewall.

8. The self-leveling paint can holder as set forth in claim 7, wherein the first and second side fold tabs each comprise a respective mount hole, the respective mount holes of the first and second side fold tabs are aligned with the respective mount holes of the first and second side mounts and attached with fasteners to allow pivoting of the cylindrical portion.

9. The self-leveling paint can holder as set forth in claim 8, wherein the respective mount holes of the first and second side mounts, and the first and second grooves are intersected by a common plane.

10. The self-leveling paint can holder as set forth in claim 4, wherein the rod comprises a support rod connected between the two substantially parallel segments, and spaced from the third linear segment.

11. The self-leveling paint can hold as set forth in claim 4, wherein after the third linear segment is received within the second hooked end of the sheet, the second hooked end of the sheet is welded.
